(19) United States
(12) Patent Application Publication
(10) Pub. No.: US 2017/0127643 A1
(43) Pub. Date: May 11, 2017

(54) CAT LITTER BOX SYSTEM

(71) Applicant: Shannon Davis WADDELL, Roanoke, VA (US)

(72) Inventor: Shannon Davis WADDELL, Roanoke, VA (US)

(21) Appl. No.: 15/257,054

(22) Filed: Sep. 6, 2016

Related U.S. Application Data
(60) Provisional application No. 62/214,250, filed on Sep. 4, 2015.

(51) Int. Cl. A01K 1/01

(52) U.S. Cl. CPC A01K 1/011

(57) ABSTRACT

The present invention provides methods and systems for a cat litter box system that includes a base that extends to an outer edge, a pair of first and second opposed sidewalls extending generally upward from the outer edge to an upper edge, the first and second pairs of opposed sidewalls intersect at defined corners, and collectively form a cavity therein. The upper edge extends generally outward and contains a frustoconical section. An insert is placed within the cavity, wherein the insert includes a base that extends to an outer edge, a pair of first and second opposed sidewalls extending generally upward from the outer edge to an upper edge, forming a cavity therein. An upper edge, extends generally outwardly from the cavity and extends generally downwardly, forming a generally c-shaped upper edge.

### CROSS REFERENCE TO RELATED PATENT APPLICATION

The present patent application/patent claims the benefit of priority of co-pending U.S. Provisional Patent Application No. 62/214,250, filed on Sep. 4, 2015, and entitled “CAT LITTER BOX SYSTEM,” the contents of which are incorporated in full by reference herein.

### FIELD OF THE INVENTION

The present invention relates generally to an improved cat litter box system, and more generally relates to a cat litter box system that is easy, safe, and sanitary to clean.

### BACKGROUND OF THE INVENTION

Cat litter is widely used today to provide absorbent material for cat waste, i.e. urine and feces. The litter is housed in a litter box or tray. The litter boxes may be covered for aesthetics and odor reduction with entry being had by a side opening in the cover.

Cat litter boxes are well-known in the art and their utility to cat owners is generally recognized. Cat litter boxes typically take the form of a box having a base and side walls, and are typically constructed of plastic or like materials.

Cat owners generally place commercially available Cat litter in the tray to provide absorbent material for cat waste, i.e. urine and feces. After a period of use by the cat, owners dispose of the used litter material and replace it with fresh material. Typical cat litter materials include clay, zeolite, corn cob, sand, or any other insoluble absorbent granular material.

The periodic disposal of used cat litter material is an undesirable, messy task. Also, the disposal of cat litter can adversely affect a women who is pregnant. The litter box itself requires periodic cleaning to assure proper hygiene and to minimize odor-formation. The present invention as described herein solves the issue of having to wash the litter box and makes litter disposal as easy as folding the rigid insert by the handles and eliminates the need for existing plastic bag liners that rip and spill contents due to cats clawing through.

### BRIEF SUMMARY OF THE INVENTION

According to an embodiment of the present invention, the present invention provides a cat litter box system that includes a base that extends to an outer edge, a pair of first and second opposed sidewalls extending generally upward from the outer edge to an upper edge, the first and second pairs of opposed sidewalls intersect at defined corners, and collectively form a cavity therein. The upper edge extends generally outward and contains a frustoconical section. An insert is placed within the cavity, wherein the insert includes a base that extends to an outer edge, a pair of first and second opposed sidewalls extending generally upward from the outer edge to an upper edge, forming a cavity therein. An upper edge, extends generally outwardly from the cavity and extends generally downwardly, forming a generally c-shaped upper edge. A handle extends generally downwardly from the c-shaped upper edge and extends generally downwardly to at least the central portion of the sidewall.

According to another embodiment of the present invention, the cat litter box system includes a raised portion disposed on the first pair of opposed sidewalls.

According to yet another embodiment of the present invention, the cat litter box system includes a hollow inner portion of the handle.

According to yet another embodiment of the present invention, the cat litter box system includes an insert composed of paper, plastic, cardboard, or post-consumer content.

According to yet embodiment of the present invention, the present invention provides a cat litter box system that includes a base that extends to an outer edge, a pair of first and second opposed sidewalls extending generally upward from the outer edge to an upper edge, the first and second pairs of opposed sidewalls intersect at defined corners, and collectively form a cavity therein. The upper edge extends generally outward and contains a frustoconical section. An insert is placed within the cavity, wherein the insert includes a base that extends to an outer edge, a pair of first and second opposed sidewalls extending generally upward from the outer edge to an upper edge, forming a cavity therein. An upper edge, extends generally outwardly from the cavity and extends generally downwardly, forming a generally c-shaped upper edge and engaging the upper edge of the base. A handle extends generally downwardly from the c-shaped upper edge and extends generally downwardly to at least the central portion of the sidewall.

According to another embodiment of the present invention, the cat litter box system includes a raised portion that is generally oval in shape.

According to another embodiment of the present invention, the cat litter box system includes a raised portion that is generally rectangular in shape.

According to another embodiment of the present invention, the cat litter box system includes a raised portion that includes a top portion and a bottom portion, wherein the top portion contains a lip and a bottom portion contains a lip.

According to another embodiment of the present invention, the cat litter box system includes a hollow inner portion for receiving the raised portion.

According to yet embodiment of the present invention, the present invention provides a cat litter box system that includes a plastic base that extends to an outer edge, a pair of first and second opposed sidewalls extending generally upward from the outer edge to an upper edge, the first and second pairs of opposed sidewalls intersect at defined corners, and collectively form a cavity therein. The upper edge extends generally outward and contains a frustoconical section. A plastic insert is placed within the cavity, wherein the insert includes a base that extends to an outer edge, a pair of first and second opposed sidewalls extending generally upward from the outer edge to an upper edge, forming a cavity therein. An upper edge, extends generally outwardly from the cavity and extends generally downwardly, forming a generally c-shaped upper edge and engaging the upper edge of the base. A handle extends generally downwardly from the c-shaped upper edge and extends generally downwardly to at least the central portion of the sidewall.

### BRIEF DESCRIPTION OF THE DRAWINGS

The present invention is illustrated and described herein with reference to the various drawings, in which like reference numbers denote like method steps and/or system components, respectively, and in which:

FIG. 1 is an exploded view of the cat litter box system;

FIG. 2 is an exploded view of another embodiment of the cat litter box system;

FIG. 3 is a perspective view the removable insert of the present invention;

FIG. 4 is a side view of the removable insert of the present invention;

FIG. 5 is side view of a wall of the litter box;

FIG. 6 is a side view of the litter box;

FIG. 7 is a side view of the litter box;

FIG. 8 is a side view of the litter box;

FIG. 9 is a top view showing the lip of the removable insert engaged to the lip of the litter box;

FIG. 10 is a top view of the removable insert; and

FIG. 11 is a side view of an alternative embodiment of the removable insert.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

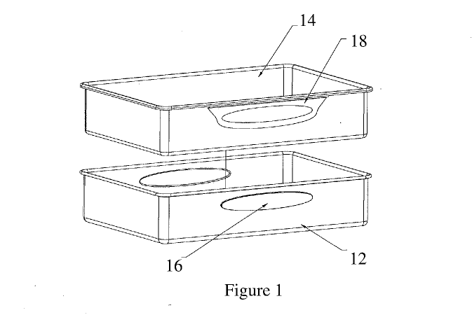

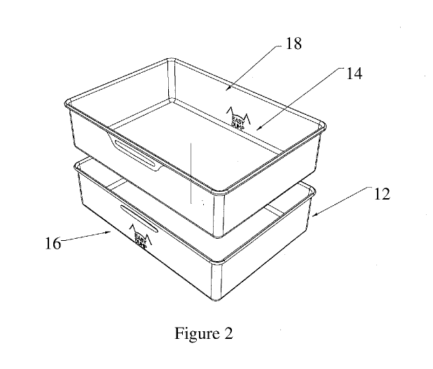

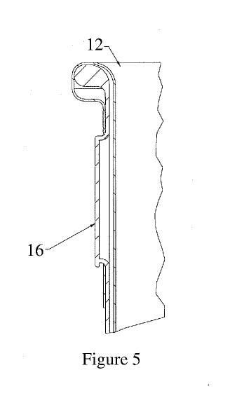

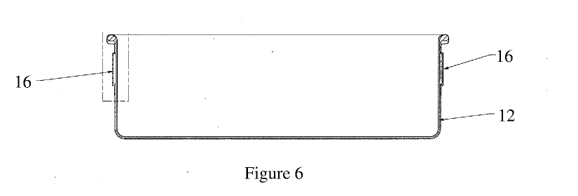

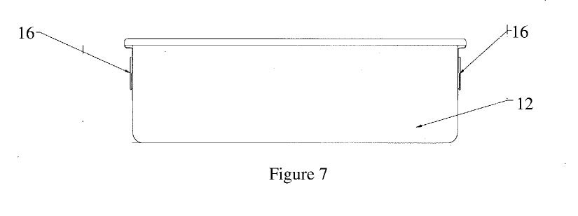

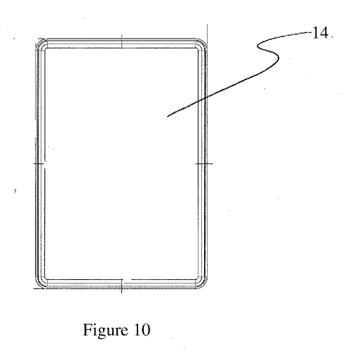

Referring now specifically to the figures, an improved cat litter box system is illustrated in FIGS. 1 and 2 and is shown generally at reference numeral 10. The system 10 includes a litter box 12 and a removable insert 14. The litter box 12 is ideally composed of a rigid material that can withstand the weight of a cat, including the weight of a cat standing on the sides of the litter box 12. As shown in FIGS. 5, 6, 7, and 10, the litter box 12 has a base that extends to an outer edge. A pair of first and second opposed sidewalls extend generally upward from the outer edge to an upper edge. The first and second opposed sidewalls intersect at defined corners, which are preferably rounded corners, and collectively form a cavity therein. The upper edge of the litter box 12 extends generally outwardly and contains a frustoconical lip section.

At least one opposed sidewall contains a raised portion 16, as shown in FIGS. 1, 2, and 5. As illustrated the raised portion 16 may have a distinctive shape, such as a generally oval in FIG. 1, circle, generally rectangular as shown in FIG. 2, etc. and preferably located in the central portion of the sidewall. The litter box 12 may be composed of a rigid plastic that is designed for multiple uses. The raised portion 16 extends outwardly from the exterior side of the opposed sidewall and contains a top portion, a lower portion, and a face portion. The top portion and bottom portion each contain a lip for retaining the handle 18 of the insert 14 by friction fit. Alternatively, the raised portion 16 contains a lip around the outer circumference of the raised portion for receiving and retaining the handle 18 of the insert 14 by friction fit.

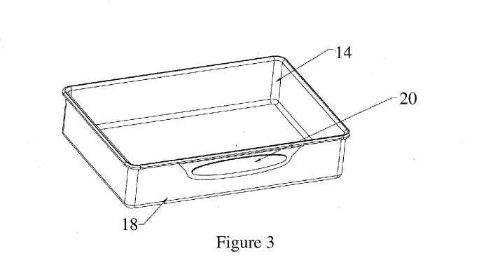

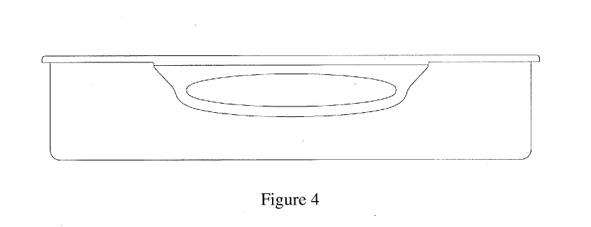

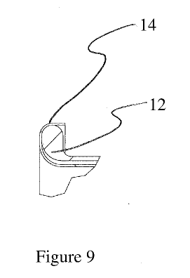

An insert 14 is designed to be placed within the cavity of the litter box 12. Like the litter box, the insert 14 has a base that extends to an outer edge, as shown in FIGS. 3 and 4. A pair of first and second opposed sidewalls extend generally upward from the outer edge to an upper edge. The first and second opposed sidewalls intersect at defined corners, which are preferably rounded corners, and collectively form a cavity therein. The upper edge, as found on one pair of opposed sidewalls, extends generally outwardly from the cavity and then extends generally downwardly, forming a generally c-shaped upper edge. As shown in FIG. 9, the c-shaped upper edge of the insert 14 is designed to fit over the frustoconically shaped upper edge of the litter box 12.

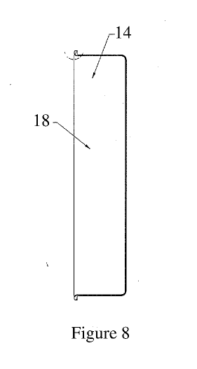

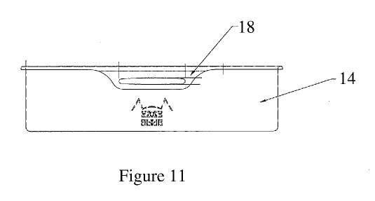

On the other opposed sidewall, the upper edge extends generally outwardly from the cavity and then extends generally downwardly, forming a generally c-shaped upper edge. A handle 18 extends generally downwardly from the c-shaped upper edge and extends generally downwardly to at least the central portion of the sidewall, as illustrated in FIGS. 1, 2, 8, and 11. As shown in FIGS. 1 and 2, the handle 18 contains a hollow inner portion 20. As illustrated, the raised portion 16 fits within the hollow inner portion 20. The hollow inner portion 20 is designed to receive the raised portion 16, forming a selectively secured arrangement between the litter box 12 and insert 14. The hollow inner portion 20 is retained to the raised portion 16 and engaged to the lip of the top portion and the bottom portion by way of friction fit that can be engaged and overcome by a simple push or pull by the user.

The insert 14 is generally made of plastic, paper, cardboard, or post-consumer content and designed for weekly disposable use, in combination with daily scooping.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A cat litter box system, comprising:
a base that extends to an outer edge;
a pair of first and second opposed sidewalls extending generally upward from the outer edge to an upper edge;
the first and second pairs of opposed sidewalls intersect at defined corners, and collectively form a cavity therein;
the upper edge extends generally outward and contains a frustoconical section;
an insert for placement within the cavity, the insert comprising:
a base that extends to an outer edge;
a pair of first and second opposed sidewalls extend generally upward from the outer edge to an upper edge, forming a cavity therein;
an upper edge, extends generally outwardly from the cavity and then extends generally downwardly, forming a generally c-shaped upper edge; and
a handle that extends generally downwardly from the c-shaped upper edge and extends generally downwardly to at least the central portion of the sidewall.

2. The cat litter box system of claim 1, further comprising a raised portion disposed on the first pair of opposed sidewalls.

3. The cat litter box system of claim 1, wherein the insert comprises a hollow inner portion of the handle.

4. The cat litter box system of claim 1, wherein the insert is composed of paper, plastic, cardboard, or post-consumer content.

5. A cat litter box system, comprising:
a base that extends to an outer edge;
a pair of first and second opposed sidewalls extending generally upward from the outer edge to an upper edge;
the first and second pairs of opposed sidewalls intersect at defined corners, and collectively form a cavity therein;
the upper edge extends generally outward and contains a frustoconical section;
an insert for placement within the cavity, the insert comprising:
a base that extends to an outer edge;
a pair of first and second opposed sidewalls extend generally upward from the outer edge to an upper edge, forming a cavity therein;
an upper edge, extends generally outwardly from the cavity and then extends generally downwardly, forming a generally c-shaped upper edge and engaging the upper edge of the base; and
a handle that extends generally downwardly from the c-shaped upper edge and extends generally downwardly to at least the central portion of the sidewall.

6. The cat litter box system of claim 5, further comprising a raised portion disposed on the first pair of opposed sidewalls.

7. The cat litter box system of claim 5, wherein the insert comprises a hollow inner portion of the handle.

8. The cat litter box system of claim 5, wherein the insert is composed of paper, plastic, cardboard, or post-consumer content.

9. The cat litter box system of claim 5, wherein the raised portion is generally oval in shape.

10. The cat litter box system of claim 5, wherein the raised portion is generally rectangular in shape.

11. The cat litter box system of claim 5, wherein the raised portion contains a top portion and a bottom portion, wherein the top portion contains a lip and a bottom portion contains a lip.

12. The cat litter box system of claim 5, wherein the handle includes a hollow inner portion for receiving the raised portion.

13. A cat litter box system, comprising:
a plastic base that extends to an outer edge;
a pair of first and second opposed sidewalls extending generally upward from the outer edge to an upper edge;
the first and second pairs of opposed sidewalls intersect at defined corners, and collectively form a cavity therein;
the upper edge extends generally outward and contains a frustoconical section;
a plastic insert for placement within the cavity, the insert comprising:
a base that extends to an outer edge;
a pair of first and second opposed sidewalls extend generally upward from the outer edge to an upper edge, forming a cavity therein;
an upper edge, extends generally outwardly from the cavity and then extends generally downwardly, forming a generally c-shaped upper edge and engaging the upper edge of the base; and
a handle that extends generally downwardly from the c-shaped upper edge and extends generally downwardly to at least the central portion of the sidewall.

14. The cat litter box system of claim 13, further comprising a raised portion disposed on the first pair of opposed sidewalls.

15. The cat litter box system of claim 13, wherein the insert comprises a hollow inner portion of the handle.

16. The cat litter box system of claim 13, wherein the insert is composed of paper, plastic, cardboard, or post-consumer content.

17. The cat litter box system of claim 13, wherein the raised portion is generally oval in shape.

18. The cat litter box system of claim 13, wherein the raised portion is generally rectangular in shape.

19. The cat litter box system of claim 13, wherein the raised portion contains a top portion and a bottom portion, wherein the top portion contains a lip and a bottom portion contains a lip.

20. The cat litter box system of claim 13, wherein the handle includes a hollow inner portion for receiving the raised portion.
